(19) United States
(12) Patent Application Publication
(10) Pub. No.: US 2010/0034605 A1
(43) Pub. Date: Feb. 11, 2010

(54) Apparatus and method thereof for drilling holes in discrete controlled increments

(76) Inventors: Sean C. Huckins, Syracuse, NY (US); Charles J. Hodge, JR., Jamesville, NY (US)

Correspondence Address: DILWORTH & BARRESE, LLP, 1000 WOODBURY ROAD, SUITE 405, WOODBURY, NY, 11797, US

(21) Appl. No.: 11/988,465

(22) PCT Filed: Jul. 10, 2006
(86) PCT No.: PCT/US06/26585

§ 371 Date: Sep. 14, 2009

Related U.S. Application Data
(60) Provisional application No. 60/697,511, filed on Jul. 8, 2005.

(51) Int. Cl. B23B 45/14; B23B 39/14; B23B 35/00

(52) U.S. Cl. 408/1 R; 408/111; 408/115 R

(57) ABSTRACT

An apparatus and method for forming a hole in material for non-medical and medical purposes such as a cranial burr hole for ventriculostomy and brain biopsy procedures. The apparatus includes a main unit upon which a drill unit is located. The drill unit includes a drill bit and an on/off switching means. The main unit includes a handle which is suitable for grasping, and an advancing mechanism including a release/engage mechanism, and an advancing lever and an optional on/off switch. The drill unit is advanced a predetermined distance relative to the main unit each time an advancing lever is pulled. In use, the apparatus is placed in a desired position upon the material to be drilled such a patient's skull and is stabilized by a stabilization platform, the apparatus is then turned on, and the advancing lever is pulled to advance the drill unit a predetermined distance relative to a longitudinal axis of the main unit with each pull of the advancing lever. The procedure is ended when the desired depth of penetration has been reached, or the material such as in the case of skull bone, has been completely penetrated.

### PRIORITY

This application claims priority under 35 U.S.C. §119 to a provisional application entitled “APPARATUS FOR FORMING BURR HOLE FOR VENTRICULOSTOMY AND/OR BIOPSY AND METHOD THEREOF” filed in the United States Patent and Trademark Office on Jul. 8, 2005 and assigned Ser. No. 60/697,511, the contents of which are hereby incorporated by reference.

### BACKGROUND OF THE INVENTION

1. Field of the Invention

The present invention relates to a portable, handheld, self-stabilizing device, and method thereof, for drilling holes in a controlled manner to a specified maximum depth, and more particularly relates to a surgical apparatus for forming burr holes for ventriculostomy or brain biopsies.

2. Description of the Related Art

There exist many situations in which a hole needs to be drilled through material in a steady, controlled manner, along a straight trajectory, and to a specified, measured depth. For example a craftsperson, hobbyist, professional model maker, cabinet-maker, carpenter, etc., may need to drill one or more straight holes in a piece of material to a nominal, measured depth. In the case of holes being drilled completely through a given piece of material, it may be advantageous to stop the drill bit from advancing beyond a specified maximum depth. Holes also may need to be drilled at a specified angle, such as perpendicular to the surface of the material being drilled. In the case of a linear or two-dimensional array of holes, it may be important that the individual holes are parallel to one another. For example, if a person is building a scale model of a house that includes a porch with railings and needs to drill a row of evenly spaced holes into which small dowels will be inserted to form a balustrade, the person may want to ensure the individual holes were to be not only evenly spaced, but of equal depth and parallel to one another.

In terms of medical problems, every year a given number of individuals will suffer from one or more of a variety of conditions requiring medical attention such as broken bones, facial fractures, head trauma, or pathological disorders such as cancer. Physicians and their assistants in fields such as orthopedic surgery, otolaryngology, and neurosurgery are often called upon to repair broken bones surgically with the placement of screws, pins, wires, and plating systems. In other instances medical specialists may need to access bone to reach tissue for biopsies. Specific to the neurological disorders are a range of pathological conditions such as brain tumor or abscess, hydrocephaly, Parkinson's disease and other movement disorders, subdural and epidural hematomas, and stroke.

Any number of neuropathological conditions can result in a population of people suffering from increased, or elevated, intracranial pressure (ICP). If left untreated, elevated ICP can result in serious neurological injury leading to coma and/or death. One way to measure, monitor, and/or reduce elevated ICP is to perform a surgical procedure known as a ventriculostomy. A ventriculostomy is a procedure in which a catheter is inserted into the anterior horn of the lateral ventricle of the brain of a patient with elevated ICP. The catheter is then used to drain cerebral spinal fluid (CSF) thereby decreasing ICP. In addition, a device can be attached to the catheter to monitor ICP levels. Insertion of a catheter into a person's brain requires penetration of the skull and therefore requires a cranial access hole. This cranial access hole, which is also commonly known as a burr hole, is formed using a conventional medical drill. The procedure is commonly known as a burr hole procedure. Burr hole procedures are also necessary for gaining cranial access for the evacuation of fluid collections, abscess drainage, and performing biopsies of pathological tissue.

For non-medical applications there exists a variety of devices and equipment designed to drill holes. These products are portable or stationary, powered by motors run by alternating or direct current, and incorporate features such as maintaining a straight trajectory for the drill bit and setting a nominal maximum depth to which a hole can be drilled. Such products include drill presses, hand held portable drills, and routers.

Drill presses are commonly used for drilling straight, even holes in a variety of material, at variable speeds, and to a specified depth. However, to work properly even so-called miniature drill presses designed to be used for scale models and other such crafts rely on the principle that the drill press must first be placed on a stationary surface, and the material to be drilled must be passed through the drill press. In other words, material to be drilled must be placed within the confines of the drill press, and the drill press is designed to remain stationary in relation to material that must be physically moved in order for a targeted start point for the hole to be drilled will be in line with the drill bit itself. Although a common feature of drill presses is the ability to manually set a maximum plunge depth that, when reached, stops advancement of the bit. However, typical drill presses do not incorporate a design feature that allows a hole to be drilled in discrete, measured increments in a manner such that advancement of the drill bit is arrested after each increment, forcing a pause or stop for the operator to assess whether or not the drill bit needs to be advanced another increment.

Hand held drills, whether they are manually driven or powered by electricity, are portable but typically do not include design features to help the user maintain a steady, fixed velocity and trajectory of the advancing drill bit. For some handheld hole drilling apparatuses there may exist a guide to aid in keeping a drilled hole at a fixed angle in relation to the surface of the material to be drilled. Also, there may exist rings, or collets, that could be manually set along a drill bit at a measured distance from the tip of the drill bit, and that would strike the surface of the drilled material once the drilled hole reaches the measured depth, thereby providing a means for the user to know when the proper depth of a particular hole has been drilled. However, there is currently no mechanical feature for advancing the bit of a hand held drill in a controlled, incremental manner in discrete, measured steps, to reach a preset maximum end point, or a measured distance inbetween.

Routers are portable, hand held tools that can be set to plunge to a preset and fixed maximum depth before cutting. The depth to which a router bit is plunged can be determined by dialing a calibrated advance mechanism, oftentimes while the router is running and in place on the material to be cut. The bit advancing feature of a router is used at the beginning of the cutting procedure to keep the router bit at desired, fixed depth throughout a specific cut. Routers are designed to cut grooves in material, or shape the edges of material, by ensuring a guide plate is flush with the material to be cut. The router is then moved along the surface of the material, typically with the edge of the guide plate of the router in contact with a guide or fence. Routers are typically not used to drill an array of holes, nor do they incorporate a design feature that allows the user the advance the whole in discrete, controlled increments in a manner described in the present invention.

Currently there are three distinct methods for forming burr holes in a patient's skull. The first method dates far back in the annals of neurosurgery and requires the use of a handheld, manually operated trephine or a crank drill to create the burr hole. Manually operated instruments such as the sterilized and disposable Fiskars® craft drill, or sterilizable and reusable Universal Bone Drill with S.S. Chuck hand cranked drill, are not precise in that drilling is relatively slow and the drill tends to wobble during operation. The wobble results from an eccentricity effected on the drill bit by the unbalanced action of the user's cranking action and can result in an imperfect burr hole, potentially causing unnecessary damage to the patient's skull and surrounding tissue. Additionally, after the skull is penetrated there is a chance that the tough protective layer covering the brain, called the dura mater, can be injured. In addition to dural injury, the brain itself can be injured if the drill accidentally plunges too rapidly or deeply into the cranial cavity. Finally, the manual, hand cranked drills are designed for right hand users despite the fact that a certain population of medical professionals using such drills are left handed.

The second method requires the use of a cordless, handheld, electric cranial drill, and the third method requires the use of a pneumatic cranial perforator. While the second and third methods reduce the wobbling effect caused by manually cranking a cranial drill, they too suffer from shortcomings. In the case of the handheld electric cranial drill one procedural risk is direct injury to the brain and/or surrounding tissue from the drill bit plunging into the cranial cavity after the skull has been penetrated by the drill bit. An inherent problem in the use of pneumatic drills is the requirement of maintaining, transporting, and setup of a cumbersome multi-component device that is not designed to be used as a portable system outside the operating room.

Moreover, all three methods require hand-stabilization of the drill so as not to cause additional damage to the patient's skull, brain, and surrounding tissue, which is oftentimes challenging due to variability inherent in human skull anatomy such as skull curvature, thickness of scalp and bone, or degree of a given patient's ability to cooperate and remain still during the procedure. As with any hand held product, device, or instrument, all the safe and successful execution of the above procedures relies on the skill and practice level of the individual executing the procedure. As a means of preventing accidental injury, medical devices are mandated by federal regulation to incorporate certain safety features in their design.

In the case of hand-crank cranial drills, reducing the likelihood of the drill bit being plunged too deeply into a patient's skull partly relies on a ring, or collet, that is supposed to be placed around the drill bit to control maximum penetration of the bit into the skull. Unfortunately, the maximum depth of penetration into a patient's skull cannot be precisely determined before the burr hole procedure. Moreover, even if the maximum penetration depth into a patient's skull were known beforehand, drilling a hole which is inadvertently not perpendicular to the skull can result in the loss of some advantages of using the safety collet. The farther a drilled burr hole is from ninety degrees to the skull surface, the less likely it is for a surgeon to pass a catheter or biopsy instrument directly to its target. That is because the trajectory may have to be altered to such an angle that the catheter or biopsy instrument may not be able to clear the edges of the hole.

The safety collet is intended to aid in the prevention of brain injury, but inadvertently drilling a hole that is not perpendicular to the skull could cause the ring to contact the skull prematurely and potentially cause binding while simultaneously preventing the drill bit from fully penetrating the skull. Any of the aforementioned problems would necessitate the adjustment of the ring during the procedure, which would not be desirable. Moreover, systems using a collet require the user to manipulate a small wrench to turn a tiny set screw for adjusting the collet's position. Repeated adjustments of the set screw may increase the time it takes to perform a procedure, and anything that unnecessarily increases time of a surgical procedure increases the risk of that procedure.

Another method used to control the penetration of a cranial drill requires the use of a specialized cranial perforator such as the Acra-Cut™ (ACRA-CUT, 989 Main Street, Acton, Mass. 01720) cranial perforator which has a built-in safety mechanism. This safety mechanism is basically a clutch that stops the drill from cutting once the skull has been perforated. The Acra-Cut™ cranial perforator functions optimally when driven by a pneumatic system at very high revolutions per minute (rpm). Such pneumatic systems are, when compared to hand-crank or electric burr hole systems, relatively costly and complicated systems that are typically not readily available in the emergency room, intensive care unit, or CT scan room where ventriculostomies and/or brain biopsies are typically performed. Moreover, they require the use of a pneumatic line to supply pressure to the device which makes the device difficult to handle and increases the risk of injury during use. In addition, once the clutch on the larger diameter Acra-cut™ cranial perforator has been automatically disengaged the perforator will no longer cut, thereby rendering the Acra-cut system sub-optimal. Acra-cut™ does manufacture a smaller diameter pediatric cranial perforator in which the clutch does not disengage when the drilling procedure is stopped, however the smaller diameter perforator is currently only compatible with a handheld/hand-drank cranial drill. The small diameter Acra-cut cranial perforator is also very expensive relative to a regular medical-grade drill bit. Accordingly, there is a need for an apparatus and method for producing precise cranial burr holes in a stable manner and with a controlled, incremental and maximum depth which can be determined before, and adjusted during, the cranial burr hole procedure.

### SUMMARY OF THE INVENTION

It is therefore a feature of the present invention to provide an apparatus and method for forming cranial burr holes in a desired location that is stabilized relatively perpendicular the point of entry on a patient's skull.

It is another aspect of the present invention to provide an apparatus and a method for forming precise cranial burr holes by advancing a drill bit in small, measured increments to a predetermined depth which cannot be exceeded.

It is yet another object of the present invention to provide a small-sized, low-power, low-cost cranial burr-hole-forming apparatus and method that is compatible with existing medical procedures, and extensible to existing medical-grade cranial drill bits and sterilization techniques.

It is a further feature of the present invention to provide a low-cost cranial drill which is compatible with present medical procedures.

It is yet another feature of the present invention to provide an apparatus and method for forming a cranial burr hole that will not damage surrounding tissue during use.

It is another feature of the present invention to provide means for forming holes by advancing a drill bit in a controlled, incremental manner through a variety of materials by drilling in discrete, measured steps.

It is yet another feature of the present invention to provide means for forming holes at known and fixed angles relative to the surface of material being drilled.

It is an additional feature of the present invention to provide means for forming holes at predetermined fixed locations relative to an unfixed object using a stability platform for transferring a force to the object being drilled and for controlling a depth of penetration of the object. Additionally, it is a feature of the present invention to provide means for locating a drill bit relative to an object being drilled such that the drill bit remains in a fixed position relative to the object.

To achieve the above features there is provided means for forming holes such as a surgical burr hole for ventriculostomy or brain biopsy procedures using a drill apparatus according to the present invention including a main unit, a handle, a stabilization platform including stabilization pins, a release/engage mechanism including an advancing mechanism and an advancing unit, and a drill unit disposed within a channel of the main unit, the drill unit further including a drill bit, the method including initializing the apparatus according to the present invention so that the drill bit does not extend beyond the stabilization platform and/or stabilization pins, holding the main unit using the handle and placing the stabilization unit including the stabilization pins upon a patient's skull in a desired location, turning the drill unit on, and advancing the drill unit relative to the main unit with a sliding action by depressing the advancing unit so that the drill unit is advanced by sliding a predetermined distance relative to the main unit each time the advancing unit is depressed, and terminating the procedure when the patient's skull has been perforated.

The apparatus and method according to the present invention provides increased levels of safety and security to a patient and reduces the time necessary to perform cranial access procedures such as ventriculostomy and brain biopsy procedures. Additionally, because the apparatus according to the present invention includes relatively few parts and is simple to construct, the apparatus is relatively inexpensive and is easily sterilized and/or disposable.

It is envisioned that the apparatus and method according the present invention also provides a simple and effective means of drilling holes for a broad range of non-medical applications such as crafts, home improvements, and the like.

### BRIEF DESCRIPTION OF THE DRAWINGS

The above and other objects, features and advantages of the present invention will become more apparent from the following detailed description when taken in conjunction with the accompanying drawings, in which:

FIG. 1 is a front perspective view illustration of the drill according to the present invention;

FIG. 2 is a side view illustration of the drill according to the present invention;

FIG. 3 is an exploded rear perspective view illustration of the drill according to the present invention shown with the drill unit detached from the main unit;

FIG. 4 is a detailed perspective view illustration of a stabilization platform of the drill according to the present invention;

FIG. 5 is a perspective view illustration of a calibrated bar and attachment means of the cranial drill according to the present invention;

FIG. 6 is a detailed rear perspective view illustration of an advancing mechanism of the drill detailing a safety depth stop ring advance bar according to the present invention;

FIG. 7 is a cutaway detailed perspective view illustration taken along line 7-7 of FIG. 2 of the cranial drill according to an embodiment of the present invention;

FIG. 8 is a detailed cutaway side view illustration of the drill according to the present invention showing the advancing mechanism;

FIG. 9A a semi-transparent side view illustration of a drill using a strap type advancing mechanism according to the present invention;

FIG. 9B is a cutaway side perspective view illustration of the drill taken along line 9B-9B of FIG. 9A;

FIG. 10 is a detailed perspective view illustration of the drill shown in FIGS. 9A and 9B;

FIG. 11 is a front perspective view illustration of the drill using a keyed guide according to the present invention;

FIG. 12A is a perspective view of the drill using an enclosed motor according to the present invention;

FIG. 12B is a perspective view of the drill shown in FIG. 12A with the left side housing cutaway to reveal the basic components of the invention according to the present invention;

FIG. 12C is an exploded view illustration of the drill shown in FIG. 12A according to the present invention;

FIG. 12D is a side view illustration of the drill shown in FIG. 12A according to the present invention;

FIG. 12E is a front view illustration of the drill shown in FIG. 12A according to the present invention;

FIG. 12F is a top view illustration of the drill shown in FIG. 12A according to the present invention;

FIG. 12G is a bottom view illustration of the drill shown in FIG. 12A according to the present invention;

FIG. 13A is a detailed perspective view illustration of the drill bit, drill transmission, and advancing motor cradle of the drill station shown in FIG. 12A according to the present invention;

FIG. 13B is a detailed assembly view illustration of the drill shown in FIG. 13A showing the drill transmission removed from the advancing motor cradle to expose the add motor cradle according to the present invention;

FIG. 13C is a detailed side view illustration of the drill shown in FIGS. 13A and B showing the drill transmission positioned in the advancing motor cradle according to the present invention;

FIG. 14 is a perspective stability platform of the drill shown in FIG. 12A according to the present invention;

FIGS. 15A and 15B illustrate a solenoid for engaging and releasing teeth 124-a.

FIG. 16 is a flow chart illustrating the method of use of the drill according to an embodiment of the present invention.

### DETAILED DESCRIPTION OF THE INVENTION

The following detailed description of the preferred embodiments of the present invention will be made with reference to the accompanying drawings. In describing the invention, explanations about related functions or constructions which are known in the art will be omitted for the sake of clarity in understanding the concept of the invention.

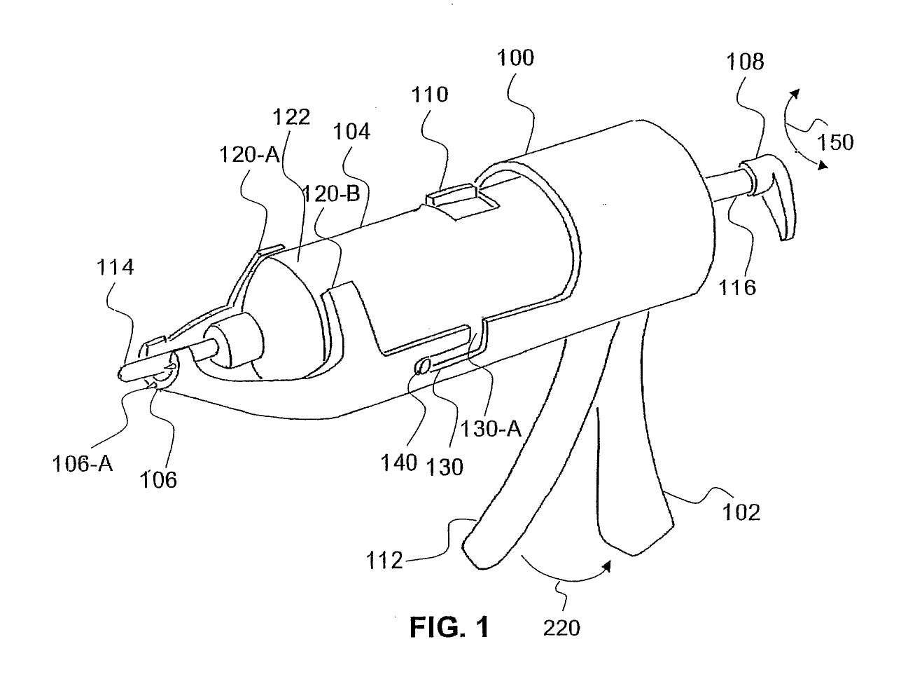

A front perspective view illustration of the drill according to the present invention is shown in FIG. 1. The drill according the embodiment of the present invention includes a main unit 100, a handle 102, a removable drill unit 104, a stabilization platform 106, an advancing mechanism 116, an advancing trigger handle 112, a power switch 110, a guide 130 and a drill bit 114. The guide 130 includes one or more guides, which will be described hereinbelow, disposed along the longitudinal axis of the main unit 100 for positioning the drill unit 104. The handle 102, along with the advancing trigger handle 112, is suitable for grasping by a user. The handle 102 is attached to, or formed integrally with, the main unit 100 so that the main unit 100 can be operably maneuvered as necessary. The advancing mechanism 116 includes an optional release/engage mechanism 108, the advancing trigger 112 and a ratcheting/advance mechanism (not shown) which will be described below.

The drill unit 104 includes a body and a guide lug 140 (only one of which is shown). The drill unit 104 preferably is a cordless unit such as a cordless battery-operated unit or a cordless pneumatically operated unit which can, for example, use a compressed gas cylinder for a motive source or any other suitable rotational motive force unit. The drill unit 104 of the present embodiment may include a battery-operated rechargeable electrical drill unit which can be removed from the main unit 100.

The drill unit 104 may include the on/off switch 110 which is disposed upon the body of the drill unit 104 However, the on/off switch 104 may also be disposed anywhere on the body of the drill unit 104, the main unit 100, or the handle 102 as desired. For example, if it is desired to place the on/off switch on the main unit 100 in a location adjacent to the handle 102 and/or the advancing lever 112, then the drill unit 104 may be equipped with optional contacts (e.g., electrical lugs) which may be coupled to contacts (not shown) located on the main unit 100 which are coupled to an on/off switch disposed on the main unit. The on/off switch would then be coupled to the drill unit and would operatively control the drill unit 104. The on/off switch may include a “dead-man” switch that will automatically turn “off” whenever pressure from the user's finger is released from the switch.

The on/off switch may further include a membrane cover which can optionally hermetically seal the interior portion of the drill unit.

The main unit's 104 guide 130 may be suitable for engaging the guide lug 140 and slideably locating the drill unit 104 relative to the main unit 100 during use. As shown, the guide 130 (only a part of which is shown) may include dual guide channels 130-A and 130-B (only one of which is shown) which are disposed along the longitudinal axis of the main unit 100, an optional first clamping mechanism 120, and an optional second clamping portion (not shown). The guide 130 and the first clamping mechanism 120 are shaped, sized and positioned to support the drill unit 104 in a desired location and to prevent the drill unit from rotating during use while allowing the drill unit to be slideably advanced along the longitudinal axis of the main unit 104 during use. During assembly of the main unit 100 and the drill unit 104, the drill unit 104 is inserted through a window portion 122 of the main unit 100. The window portion 122 also allows the user of the apparatus to view the drill unit 104 as it is advanced relative to the main unit 100 during use. The window portion also allows the clamping portion 120 to provide a desired biasing force upon the body of the drill unit 104 by allowing the clamping portion's 120 wings 120-A and 120-B to spread apart as necessary under a biasing force when the drill unit 104 is properly inserted as shown. The drill unit may be held in position by a clamping force provided by the clamping mechanism 120 and by the optional guide 130.

The stabilization platform 106 may be disposed at a distal end of the main unit 100 adjacent to a drill bit 114. The stabilization platform 106 can be formed integrally with the main unit 104 and includes a plurality of stabilization pins 106-A which are suitable for engaging the material to be drilled such as bone. Although three stabilization pins 106-A are shown attached to the stabilization platform 106, any number or stabilization pins 106-A can be used provided that the stabilization pins 106-A are spaced so that the platform remains stable during use. For example, three equidistantly-spaced stabilization pins 106-A are preferable, but any other number preferably greater than three can be used. The stabilization pins 106-A are preferably spaced apart from each other so as to provide a desired level of stability to the main unit 100 during use. The stabilization pins 106-A are preferably formed from a hardened material (e.g., surgical-grade stainless steel) and are attached using a screw means into the main unit but, in alternative embodiments, it is envisioned. However, the stabilization pins 106-A may also be formed integrally with the main unit 104 and/or may be secured to a stabilization platform which is removable from the main unit.

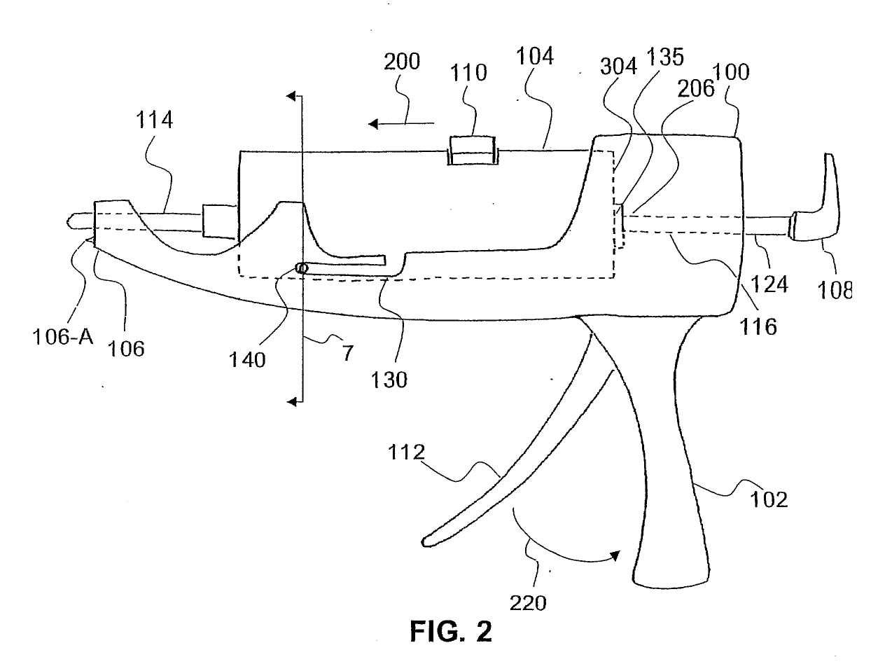

A side view illustration of the drill according to the present invention is shown in FIG. 2. The drill unit 104 is shown fully inserted within the guide 130 of the main unit 100. The advancing mechanism 116 advances the drill unit 104 a predetermined amount (e.g., 1 mm, etc.) along the longitudinal axis of the main unit 100 in the direction of arrow 200 each time the advancing lever 112 is activated (e.g., pulled in the direction of arrow 220) by a user so that the drill bit 104 extends outward from the main unit. The drill unit 104 when, in an initial position, is situated such that the drill bit 114 does not substantially extend beyond the stabilization platform and/or the stabilization pins. The initial position can preferably be adjusted so that the present invention is compatible with differently-sized drill bits 114. The drill bit 114 is preferably a surgical-grade drill bit. As described above, the advancing mechanism 116 may include the advancing lever 112, the release/engage mechanism 108, a calibrated bar 124, a ratcheting mechanism (not shown), and a locking member 135. The advancing lever 112 is coupled to the calibrated bar 124 such that each pull of the advancing lever 112 causes the calibrated bar 124 to move a predetermined distance (e.g., 1 mm) in a direction which is parallel to the longitudinal axis of the main unit 100 as indicated by arrow 200. A suitable couple includes a friction, pawl, gear (e.g., rack and pinion), etc. mechanism as is known in the art. In the preferred embodiment, a toothed mechanism and a pawl are used. The release/engage mechanism 108 may be engaged by twisting the release/engage mechanism 108 in a direction as indicated by arrow 150 so as to disengage the release/engage mechanism and allow it to be freely moved (as will be described below). Plunger 206 abuts against a rear wall 304 of the drill unit 104 and may be locked into place by the locking member 135. However, alternative But, in alternative release/engage means as are known in the art may also be used. For example, a locking tab mechanism, a friction mechanism, a screw mechanism, and/or an adhesive may be used as desired. When properly inserted within the main unit 100, the drill unit 104 is coupled to the release/engage mechanism 108 and is advanced or retracted relative to the main unit 108 in the direction of (or in the direction opposite to) arrow 200. Moreover, the optional guide lug 140 is inserted within optional guide 130.

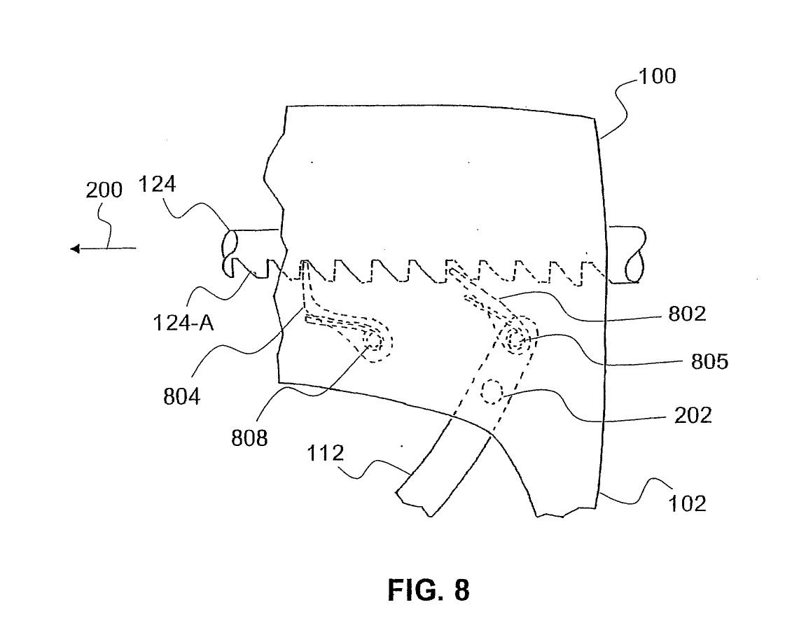

The advancing lever 112 preferably includes an optional biasing member (e.g., a spring, etc., which is not shown) which returns the advancing lever 112 to a predetermined position after each pull. In use, the advancing lever 112 preferably rotates about an axis point 202 (shown in FIG. 8—mounted to the main unit 102 for exemplary purposes but which can also be located at other locations such as the body of the drill unit 104 if so desired) relative to either or both the main unit 100 and the handle 102. Moreover, the advancing lever may be slideably located relative to the main unit. The advancing lever 112 may also include a safety release mechanism which can turn the drill unit off and/or retract the drill unit (e.g., move the drill unit in a direction of or opposite to arrow 200) depending upon pressure, the number of depressions, etc.

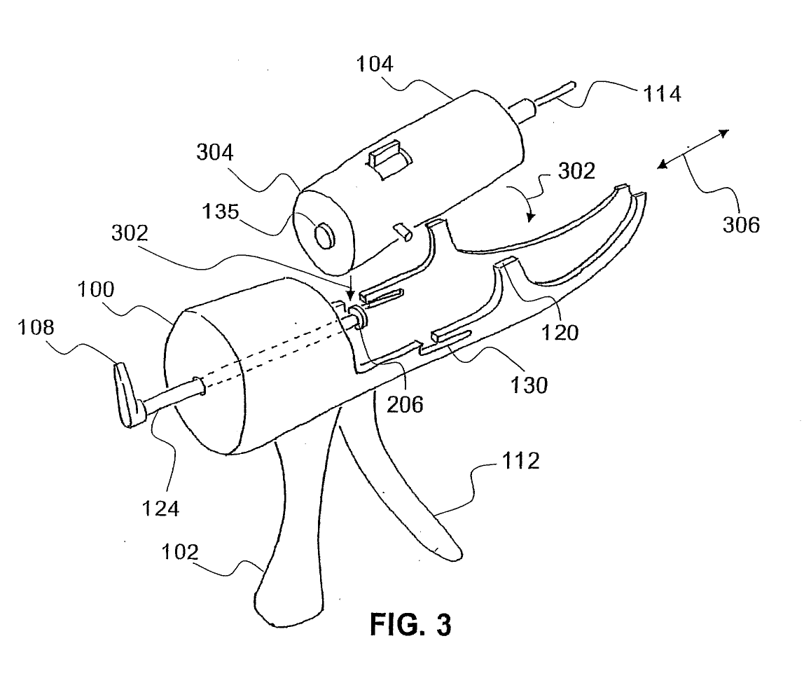

An exploded rear perspective view illustration of the drill according to the present invention shown with the drill unit detached from the main unit is shown in FIG. 3. The drill unit 104 includes the rear wall 304, a locking member 135, and lug 302, and is inserted into the main unit 100 by maneuvering the drill unit 104 in the direction of arrows 310 and 312, so that the drill unit 104 rests within the main unit's 100 body and may be located and/or positioned by any of the optional clamping portion 120, the optional guide 130, the plunger 206 and/or the main unit's base (not shown). The clamping portion 120 provides a biased clamping force for locating the drill unit 104 in a desired position while allowing the drill unit 104 to slide relative to the main unit 100. After assembly of the drill unit 104 to the main unit 100, the drill unit 104 is coupled to the release/engage mechanism 108 (via the plunger 206 and/or the optional locking member 135) which provides a force for slideably locating the drill unit in a direction as indicated by arrow 306 (or in a direction opposite to arrow 306) which is parallel to the main unit's 100 longitudinal axis. In use, the user (e.g., surgeon, etc.) in order to slideably advance the drill unit 104 and hence the drill bit 114 relative to the main unit 100, engages the advance mechanism 116 and then pulls the advancing lever 112 a predetermined amount so as to slideably advance the drill unit 104 relative to the main unit 100. Each pull on the advancing unit slideably advances the drill unit 104 a predetermined amount.

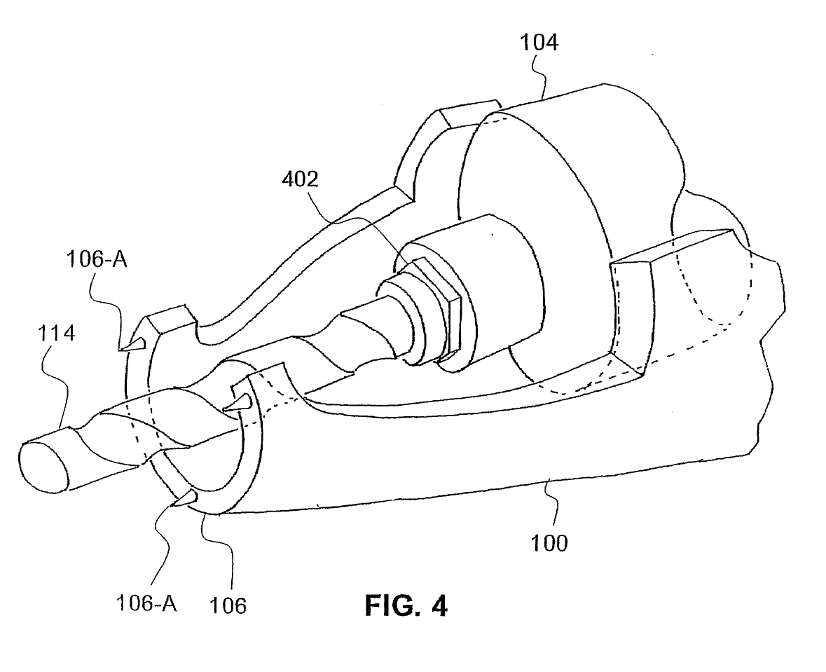

A detailed perspective view illustration of a stabilization platform of the drill according to the present invention is shown in FIG. 4. The stabilization platform 106 is preferably located so that it is perpendicular to the drill bit 114 and includes a plurality of stabilization pins 106-A. As described above, either or both the stabilization platform 106 and/or the stabilization pins 106-A can be formed integrally with or separately the main unit 100. For example, the stabilization platform 106 may be formed from a ring that is screwably, frictionally, etc., mounted to the main unit 100. Likewise, the stabilization pins 106-A may be screwably, frictionally, etc., attached to either or both the stabilization platform 106 and the main unit 100. Preferably, the stabilization pins and all other components are mounted so that they will not disengage unexpectedly from their desired mounting locations. The collet 402 can be a hex-set type and is used to fasten the drill bit 114 in position so that the drill bit does not rotate relative to the collet 402 during use. An optional mechanism (e.g., a pin, etc.) to prevent rotational movement of the drill's shaft (not shown) when tightening the collet 402, is well known in the art and is not shown for the sake of clarity.

In alternative embodiments, the stabilization platform in pivotably attached on one or more axis to the main unit so that the drill bit can be located at a desired angle relative to the stabilization platform.

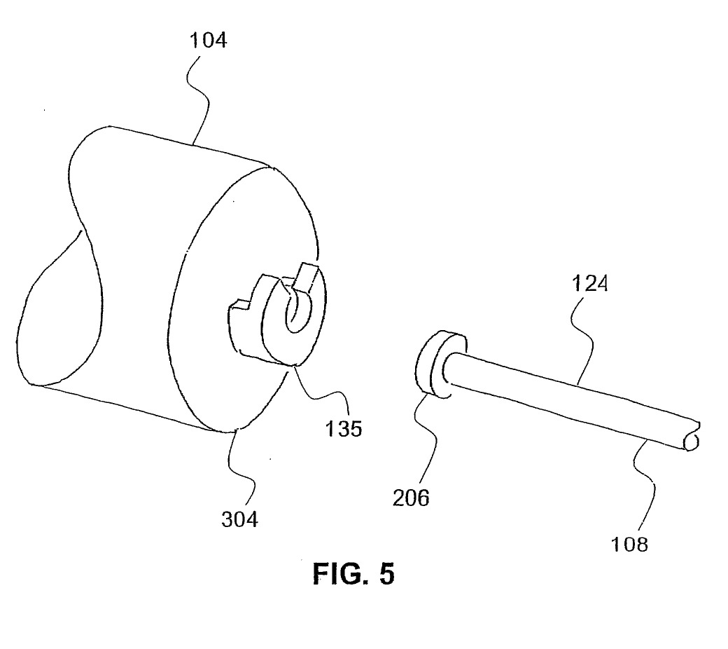

A perspective view illustration of a calibrated bar and attachment means of the cranial drill according to the present invention is shown in FIG. 5. The calibrated bar 124 is shown with the release/engage mechanism 108 and the plunger 206 attached. In use, the locking member 135 of the drill unit 104 is positioned such that the plunger 206 can slide into the locking member 135 and be locked into place using friction or other holding mechanism (e.g., a locking tab, etc.). For example, the locking member 135 may beis shaped and sized such that when the plunger 206 is inserted within the locking member 135, the locking member 135 may exert a frictional force against the plunger and/or the calibrated bar 124.

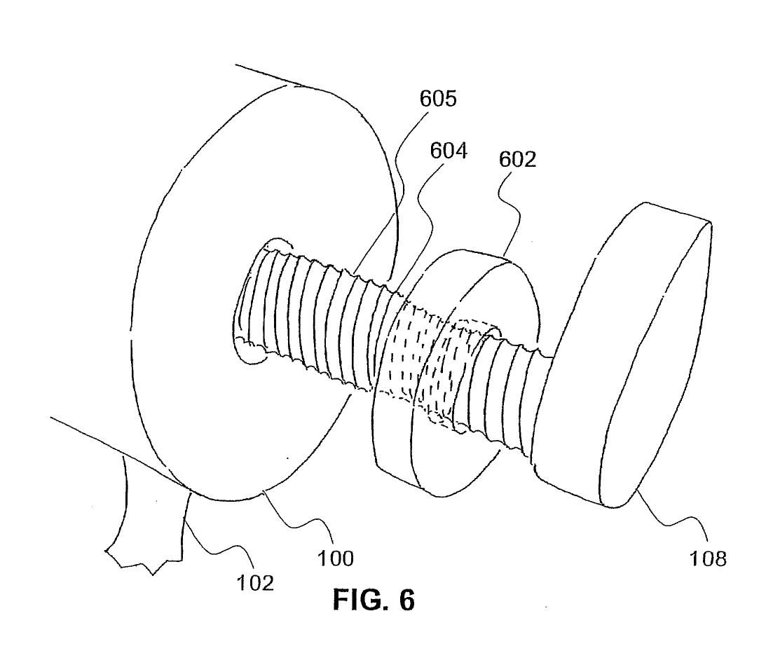

A detailed rear perspective view illustration of an advancing mechanism of the drill detailing a safety depth stop ring advance bar according to the present invention is shown in FIG. 6. The calibrated bar 124 includes optional threads 604 having a predetermined spacing “d” (605) (e.g., 1 mm as shown). The optional threads 604 are provided on a rear-most portion of the calibrated bar 124. A stop member 602 is screwably located on the calibrated bar 124 such that the stop member 602 can be located in a desired position relative to the calibrated bar 124. In use, the extent of travel of the calibrated bar 124 (and thus the attached drill unit 104) can be limited by locating the stop member 602 in a predetermined position on the calibrated bar 124 that the stop member 602 contacts the main unit 102 after the drill unit (and the calibrated bar 124) move a desired amount. The stop member 602 contacts the main unit 100 when the extent of the allowed travel is reached. Accordingly, the maximum depth if a drilled hole may be adjusted using the stop member 602.

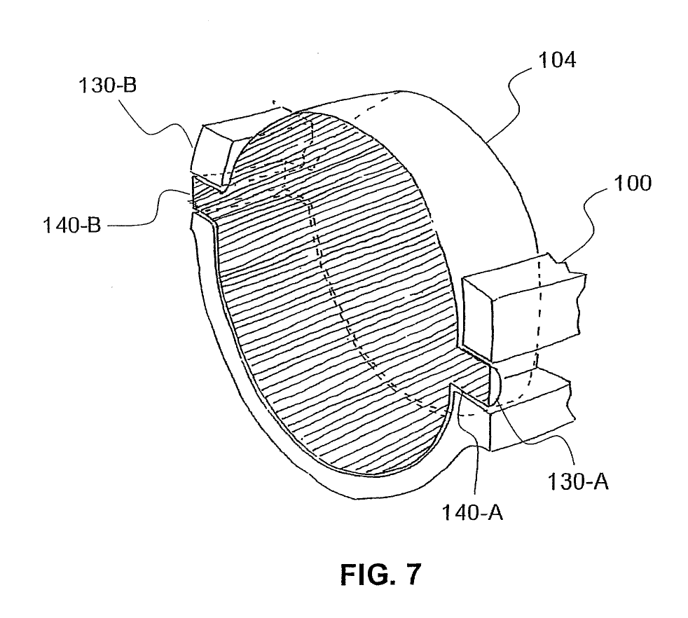

A cutaway detailed perspective view illustration taken along line 7-7 of FIG. 2 of the cranial drill according to an embodiment of the present invention is shown in FIG. 7. The main unit's 100 guide 130 includes guide 130-A and guide 130-B preferably located on opposite sides of the main unit 100. The guide lug 140 of the drill unit includes guide lug 140-A and guide lug 140-B which are shown positioned within guide 130-A and guide 130-B of the main unit 100, respectively. The guide 130 and the guide lug 140 should be shaped and sized such that a desired fit is achieved. For example, if it is desired that a frictional force be exerted on the guide lug 140 by the guide 130, then a tight fit is desirable. Alternatively, if a loose fit is desired, then the guide 130 should be shaped and sized such that the guide lug 140 can move freely within the guide 130. Moreover, a friction reducing coating (e.g., Teflon), can be applied to either, or both, the guide 130 or the guide lug 140, as desired to reduce friction.

A detailed cutaway side view illustration of the drill according to the present invention showing the advancing mechanism is shown in FIG. 8. The calibrated bar 124 includes teeth 124A which have predetermined spacing. The advancing lever 112 is attached to the main unit 100 at pivot 202 using a pin, a lug, a stud or any other suitable member (e.g., a screw, rivet, etc.). A first pawl 802 is pivotably attached to the advancing mechanism 112 and is held against the calibrated bar 124 by a biasing member 805. The calibrated bar 124 is shown with the first pawl 802 engaged with the teeth 124A of the calibrated bar 124, which is known as an “engaged” position and is a position in which pressing the advancing lever 112 would cause the calibrated bar to move a predetermined distance. Alternatively, when “released,” the calibrated bar 124 may be (as shown by arrow 150 in FIG. 1) using the release/engage mechanism 108 so that the first pawl 802 does not engage the teeth 124A of the calibrated bar 124. In the released position, the calibrated bar 124 can be freely moved in the direction of arrow 200 and in an opposite direction. A second pawl 804 is pivotably attached to the main unit 100 using a pin or other suitable joint so that the second pawl 804 may rotate about pin 808. The second pawl 806 is located relative to the main unit 100 and includes a biasing member (e.g., a spring) for causing the second pawl 804 to maintain contact with the calibrated bar 124 such that in the engaged position the second pawl 804 contacts the teeth 124A of the calibrated bar 124 and prevents the calibrated bar 124 from moving in a direction opposite to arrow 200, and in the disengaged position allows the calibrated bar to move in the direction of arrow 200 and/or in an opposite direction.

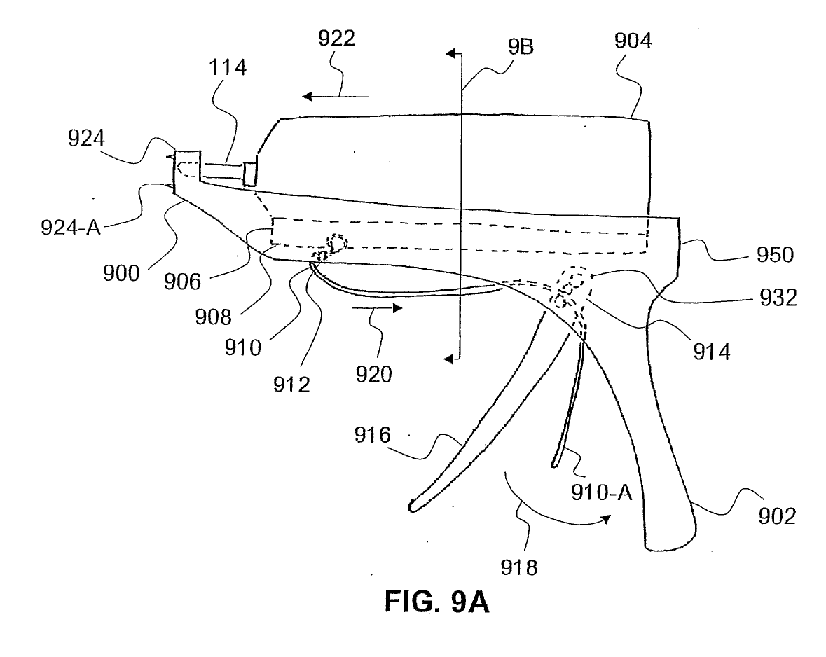

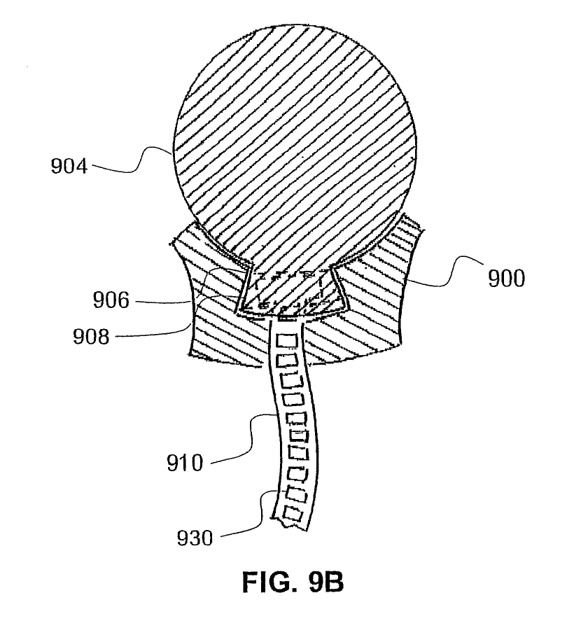

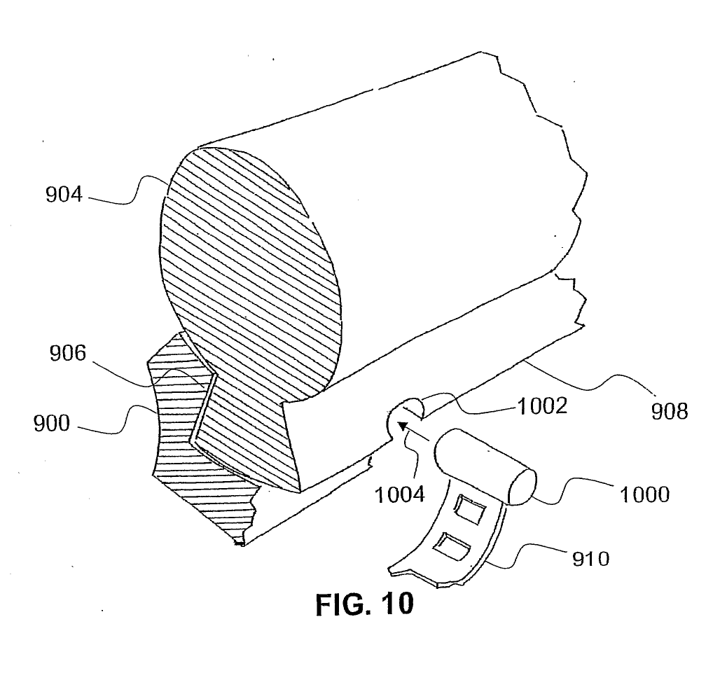

A semi-transparent side view illustration of a drill using a strap type advancing mechanism according to the present invention according to a first alternative embodiment is shown in FIG. 9A. Drill unit 904 that has a keyed guide 908 which extends along a substantial portion of the drill unit's 904 body and is shaped to fit into a channel 906 of the main unit 900. The channel 906 starts at a rear portion 950 of the main unit 900 and extends in a direction which is parallel to the longitudinal axis of the main unit 900. A strap 910 (e.g., a tie-wrap-like strap made from nylon or other suitable flexible material such as stainless steel) is attached at one end to the drill unit 904 as will be described below. The strap 910 is then wrapped around a guide pin 912 and is engaged by an advancing mechanism 914. The keyed guide 908 of the drill unit 904 is slid (in direction of arrow 922) into the channel 906, after the strap 910 is successfully inserted through advance mechanism 914. The user can grasp main unit 900 using handle 902 and/or trigger advancing trigger 916 to maneuver the device. In use, the drill unit 904 is advanced in discrete, measured increments when the user pulls trigger advancing lever 916 in direction of arrow 918 which activates an advancing mechanism 914 to pull strap 910 in direction of arrow 920, thereby advancing drill unit 904 (and therefore drill bit 114) in direction of arrow 922. The main unit 900 is stabilized against the patient's skull using stabilization platform 924 and pins 924-A of the stabilization platform. The advancing mechanism includes a pawl 932 which engages the strap 910 to pull on the strap 910 when the advancing lever 916 is pulled in the direction of arrow 918.

A cutaway side perspective view illustration taken along line 9B-9B of FIG. 9A is shown in FIG. 9B. The strap 910 has calibrated teeth 930 which are engaged by the pawl 932 such each pull of the advancing trigger causes the strap 910 to move the drill unit 904 a predetermined distance relative to the main unit 900. The calibrated teeth 930 can be formed by perforating portions of the strap 910. However, if desired, calibrated teeth may be formed on the surface of the strap 910. To release the drill unit 904, the pawl 932 is released from the strap 910. An end 910-A of the pull strap 910 is shown in an extended position for illustration only. The channel 906 and/or the keyed guide 908 can be optionally coated with a friction reducing material.

A detailed perspective view illustration of the drill shown in FIGS. 9A and 9B is shown in FIG. 10. To attach the strap 910 to the drill unit 904, an end 1000 of the strap 910 is inserted into slot 1002 of key 908 in direction of arrow 1004. The strap 910 may also be attached to the drill unit 904 using an adhesive or other suitable means.

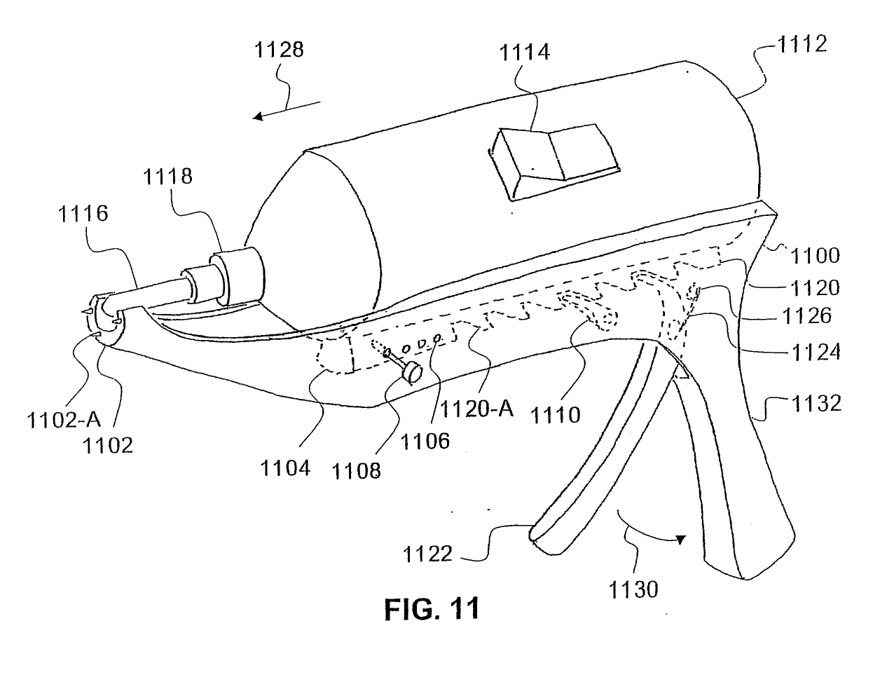

A front perspective view illustration of the drill using a keyed guide according to the present invention is shown in FIG. 11. A main unit 1100 includes a stabilization platform 1102, stabilization pins 1102-A, a channel 1104, at least one optional calibrated safety-stop setting hole 1106, a handle 1132, an optional safety-stop pin 1108, and an advancing mechanism (including a spring and a first pawl) 1110 (to keep a drill unit 1112 from sliding in a rearward direction), an advancing lever 1122 including a second pawl 1124 and a second biasing means such as a spring 1126. A second biasing means (e.g., a spring—not shown) is used to bias the advancing trigger 1122. The advancing lever 1122 is positioned in, and articulates with, the main unit 1100 through a joint such as a pin 1126. The drill unit 1112 includes an optional power switch 1114, a drill bit 1116 (an optional hex set 1118, a rotating shaft (not shown) for rotating the drill bit 1116, and/or a keyed guide 1120.

The drill unit 1112 is attached to the main unit 1100 in a manner similar to that which is shown in FIGS. 9A, 9B and 10 by inserting the drill unit 1112 into a channel 1104 in the direction of arrow 1128. The channel 1104 starts at an end of the main unit 1100 and is similar to the channel shown in FIGS. 9A, 9B and 10. Likewise, the keyed guide 1120 is similar to the keyed guide 908 shown in FIGS. 9A, 9B and 10 above, with a difference being that calibrated teeth 1120A (having a predetermined spacing) are attached to (or formed integrally with) the keyed guide 1120. The calibrated teeth 1120A are similar to the teeth 124A on the calibrated bar 124 in as shown in FIG. 8, with a difference being that the teeth are formed on the on keyed guide 1120, rather than on the calibrated bar 124. A release/engage mechanism (not shown) is provided to allow the drill unit 1112 to be freely moved (in the direction of arrow 1128 and in the opposite direction) and/or removed from the main unit 1100. Suitable release/engage mechanisms include any suitable mechanism which would release the first and second pawls 1110 and 1124 from the calibrated teeth 1120A. For example, levers and/or shafts attached to or engaging with the pawls may be used.

In use, the drill unit 1112 is slid into the main unit 1100 so that advancing mechanism (e.g., the first and second pawls 1110 and 1124, respectively) contact the teeth 1120A. The optional safety-stop pin 1108 may be set into a predetermined location (e.g., located in a predetermined calibrated safety-stop setting hole 1106) to prevent penetrating beyond a maximum depth. The drill unit 1112 is advanced in the direction of arrow 1128 in discrete, (e.g., one millimeter) increments when the advancing trigger 1122 is moved in the direction of arrow 1130 which causes the second pawl 1124 to contact an adjacent tooth of the teeth 1120A and cause the drill unit to move forward (in the direction of arrow 1128) a predetermined amount. To prevent excessive forward movement of the drill unit 1112, the forward movement of the drill unit 1112 (i.e., movement in the direction of arrow 1128) is stopped when the front of the keyed guide 1120 contacts the optional safety stop pin 1108 which was inserted into one of the calibrated safety stops 1106. Alternatively, the user can stop the forward movement of the drill unit 1112 when the user detects a slight change in the resistance of the spinning drill bit 1116 against the material which is being cut (e.g., a skull), indicating successful penetration of the material.

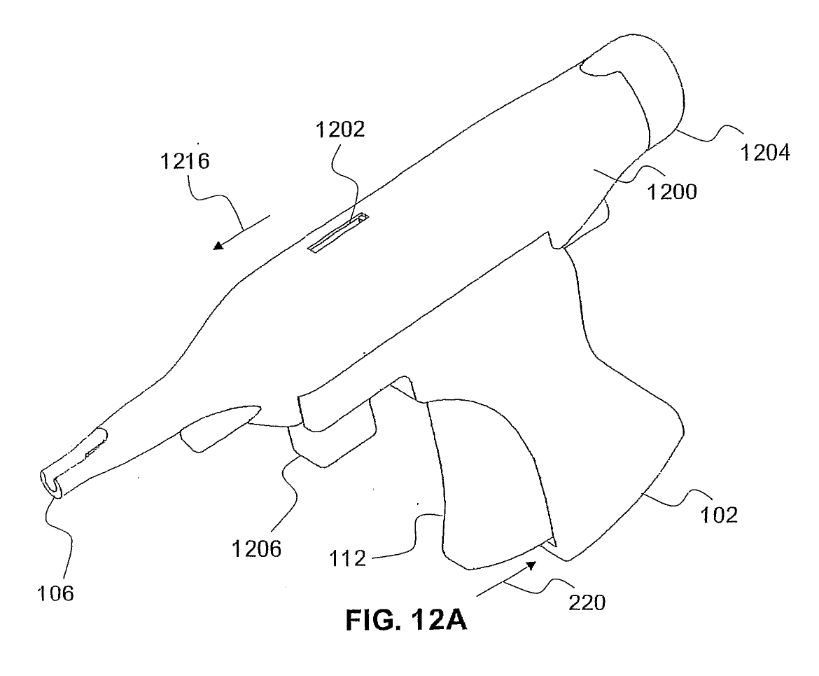

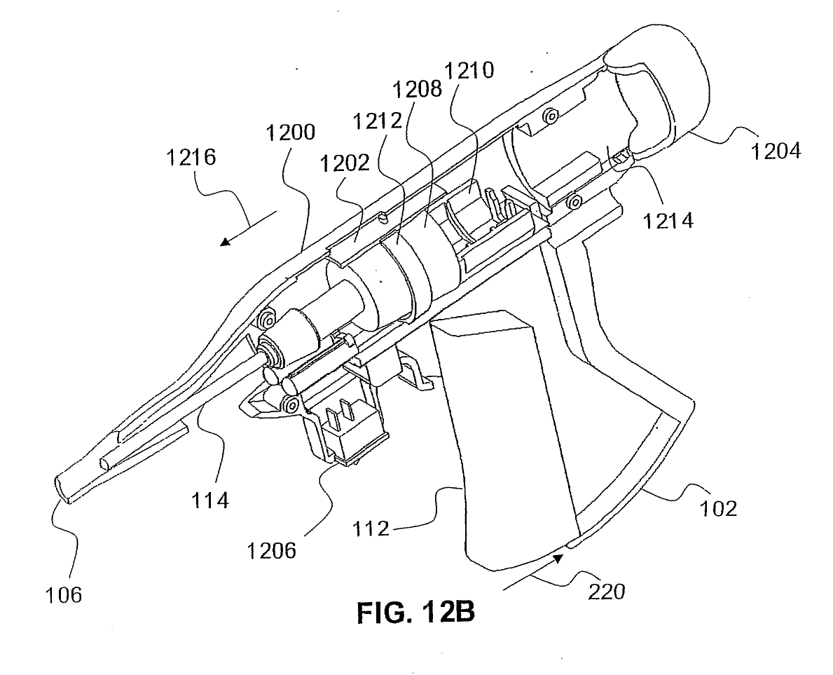

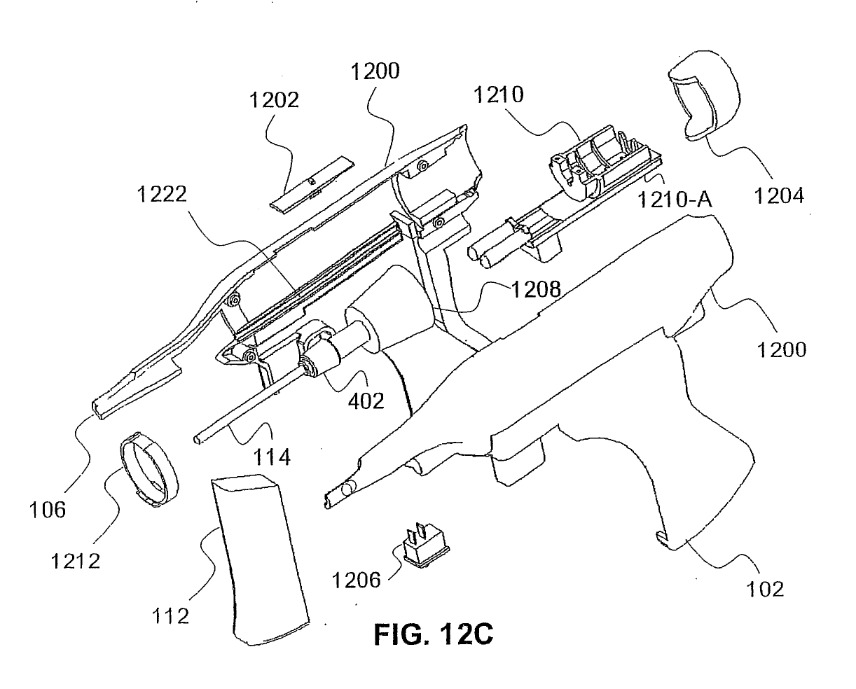

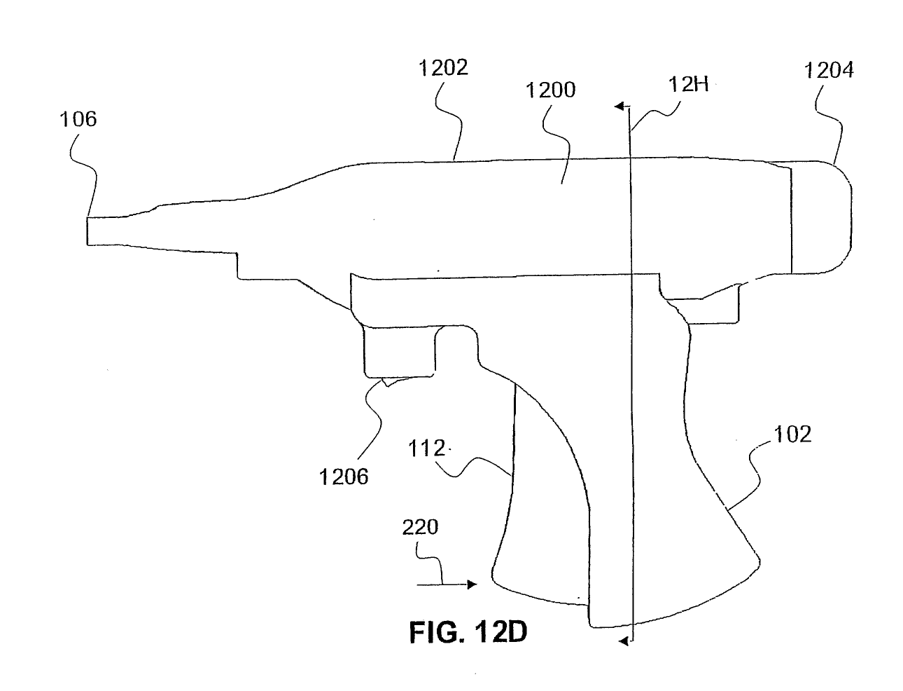

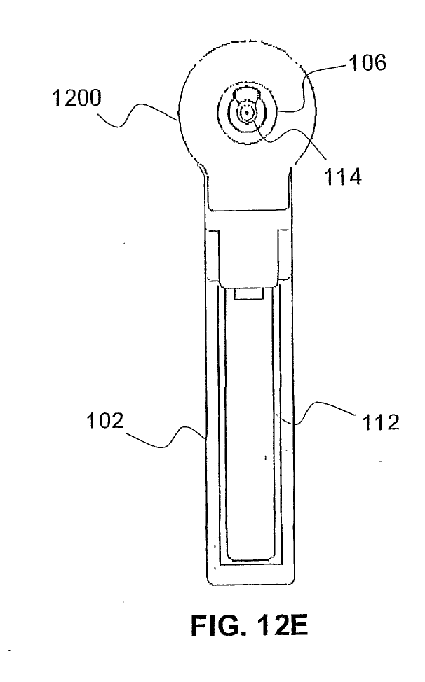

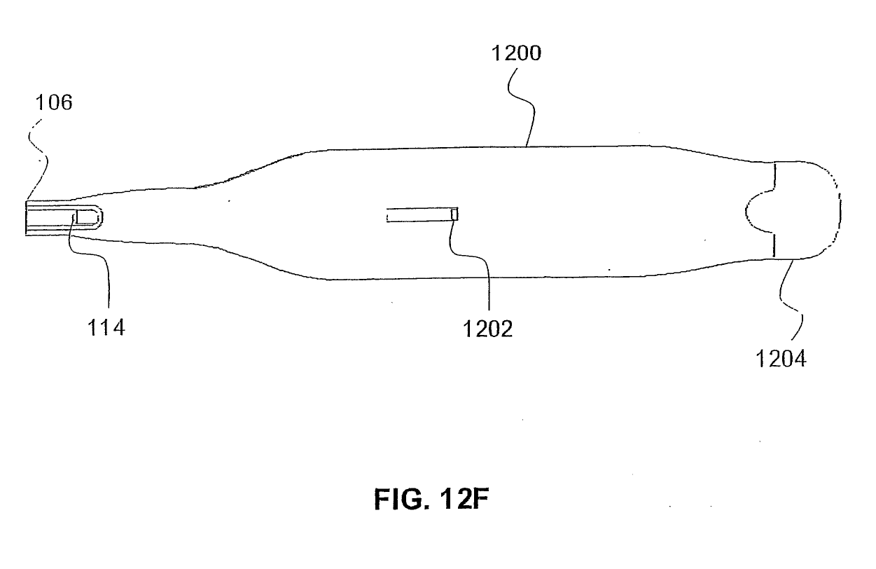

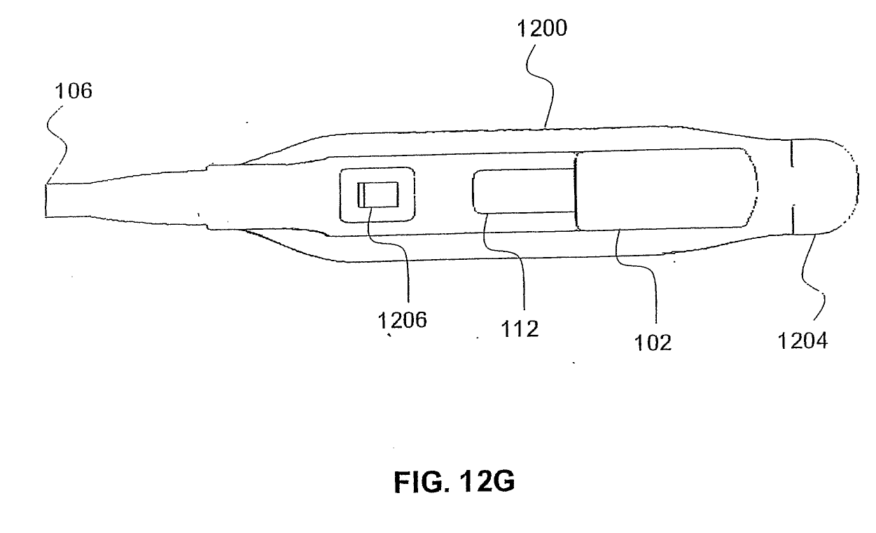

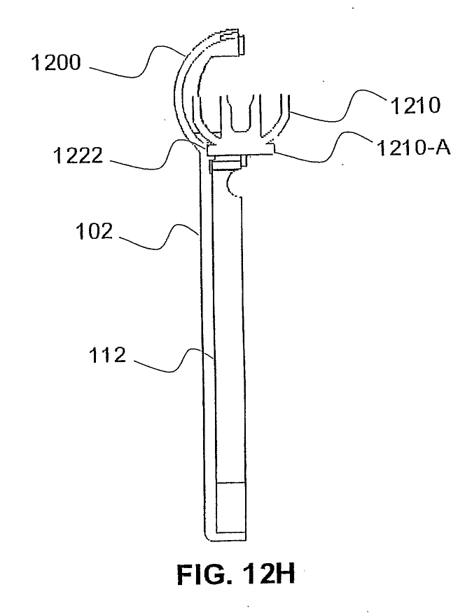

FIG. 12A is a perspective view of the drill using an enclosed motor according to the present invention. A housing includes a left right portions. Each portion includes a guide for locating a carriage unit 1210. A penetration depth of a drill bit 114 into a desired object can be monitored using a calibrated scale bar 1202 that indicates travels along direction 1216 in discrete, measured increments that are in sync with each pull of trigger handle 112 along direction 220 while the user grips the handle 102 of the main unit 1200. The drill can be powered on by using the switch 1206. A stability platform 106 is used to stabilize the drill upon a surface of the object to be drilled. An end cap 1204 is situated at an end of a battery compartment 1214.

FIG. 12B is a cutaway perspective view with the left half of housing 1200 removed. The right half of housing 1200 remains to reveal the motor and transmission unit 1208 with a ring 1212 that is positioned around motor unit 1208 and which holds the calibrated scale bar 1202 as it advances in discrete increments with every pull of trigger 112 along direction 220. Also revealed in FIG. 12B is the motor and transmission carriage 1210, power switch 1206, and a cavity that holds batteries inserted into battery cradle 1204. Also shown is drill bit 114 and stability platform 106.

FIG. 12C is a perspective exploded assembly view showing the left and right halves of main unit 1200, calibrated scale bar 1202, cap of battery cradle 1204, power switch 1206, motor and transmission unit 1208, motor and transmission carriage 1210, ring 1212 to rigidly fix scale bar 1202 to motor and transmission unit 1208, drill bit 114, drill chuck 402, stability platform 106, pull trigger handle 112 and handle 102 of main unit 1200.

FIG. 12D is left side view of the drill showing the main unit 1200, an arrow indicating the general location of calibration scale bar 1202, cap of battery cradle 1204, power switch 1206, handle 102 of main unit 1200, and trigger handle 112 that moves the drill bit forward through stability platform 106 with every pull along direction 220.

FIG. 12E is a front unit of the drill showing the main housing 1200, stability platform 106, handle 102 of main unit 1200, and pull trigger handle 112.

FIG. 12F illustrates a top view of the drill showing main unit 1200, calibrated scale bar 1202, cap of battery cradle 1204, stability platform 106, and tip of drill bit 114.

FIG. 12G is a bottom view of the drill showing the main housing 1200, cap of battery cradle 1204, power switch 1206, handle 102 of main unit 1200, stability platform 106, and pull trigger 112.

FIG. 12H is a cross sectional view taken along line 12H-12H of FIG. 12D. The carriage 1210 is seen positioned within guides of main housing 1200 such that the carriage 1210 can move along the longitudinal axis of the body.

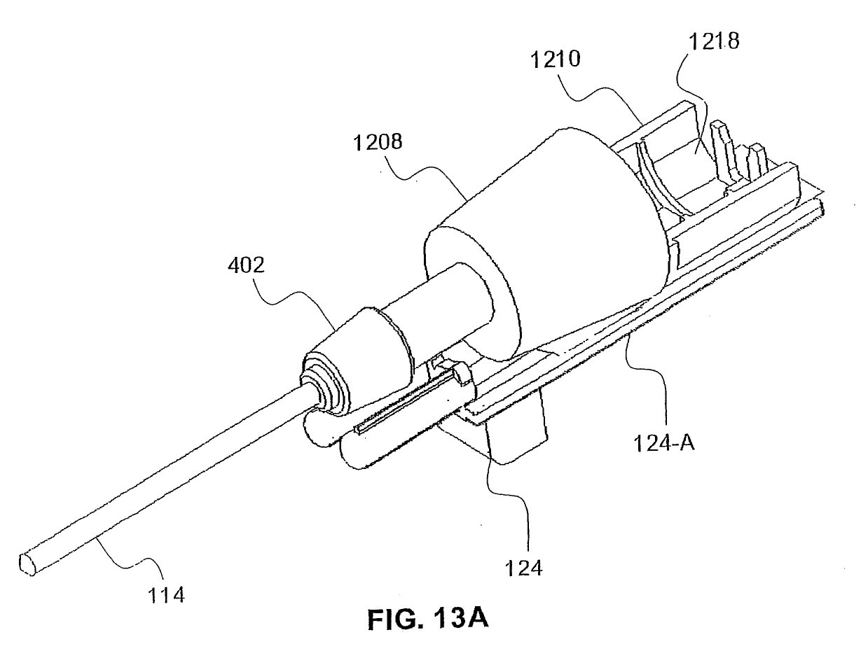

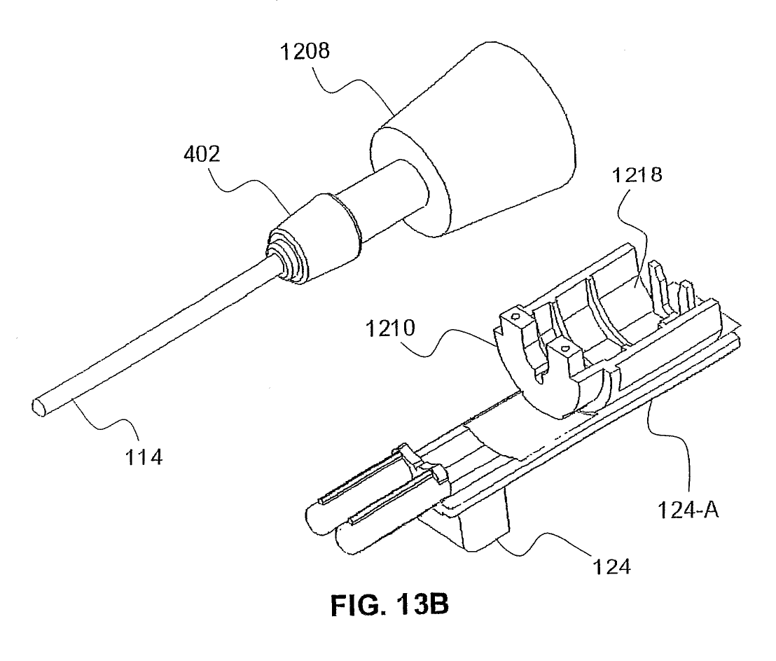

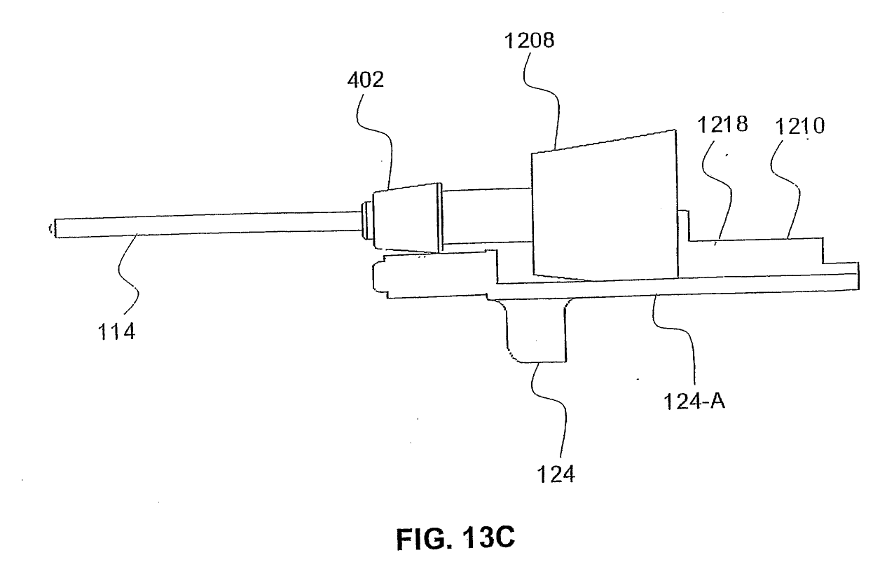

FIG. 13A shows a perspective drawing of motor transmission 1208 with chuck 402 and drill bit 114 resting in advance carriage 1210. Arrow 1218 indicates the position of the motor (not shown). Also described here is one embodiment of ratchet bar 124 with teeth 124-A, all envisioned as part of advancing motor and transmission carriage 1210.

FIG. 13B is a simple assembly diagram showing transmission and motor unit 1208 (motor not shown) elevated off advance carriage 1210. Drill bit 114 is shown in chuck 402 of transmission and motor unit 1208. Ratchet bar 124 with gear teeth 124-A of advance carriage 1210 are also shown in FIG. 13B. Arrow 1218 indicates space where motor of transmission and motor unit 1208 would rest when the drill is fully assembled.

FIG. 13C is a side view showing motor and transmission unit 1208 resting in place on advance carriage 1210. Also shown are drill bit 114, chuck 402, space 1218 for motor in advance carriage 1208, and ratchet bar 124 with gear teeth 124-A of advance carriage 1208.

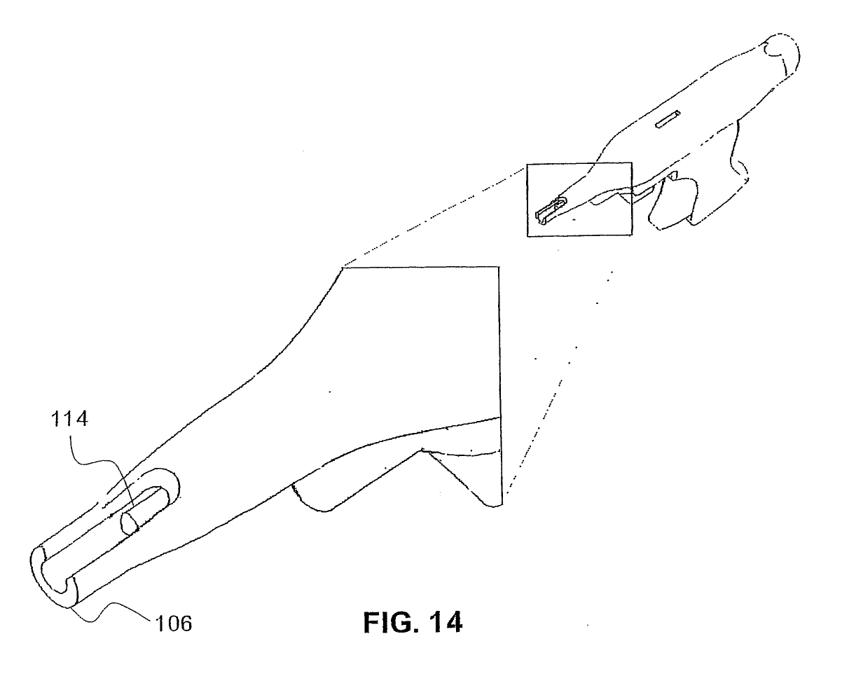

FIG. 14 illustrates the front end of the drill the stability platform 106 is shown, as is the tip of drill bit 114.

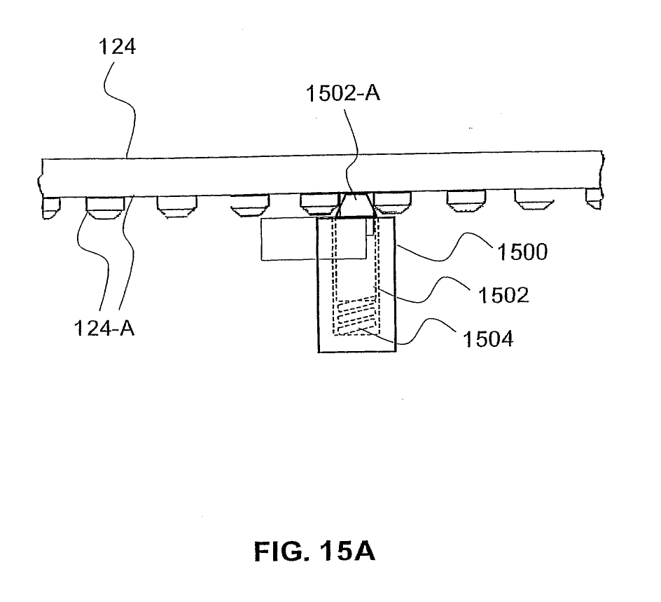

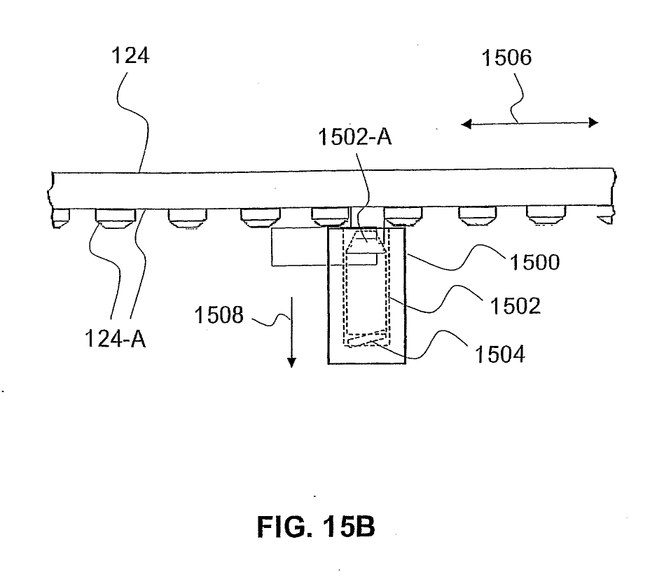

FIGS. 15A and 15B illustrate a solenoid for engaging and releasing teeth 124-a. The solenoid 1500 can be activated by a pressure or position activated switch. It is envisioned that one embodiment of a mechanism for advancing the motor and transmission carriage 1210 is illustrated in FIGS. 15A and 15B. FIG. 15A illustrates solenoid 1500 that operates piston 1502, positioned above spring 1504. Tip 1502-A of piston 1502 is initially located in a gear slot 124-A of advance ratchet mechanism 124. FIG. 15B illustrates how it is envisioned that solenoid 1500 would be included in the circuitry of the drill and would change polarity upon depression of the drill advance trigger. Changing polarity of solenoid 1500 would cause piston 1502 and piston tip 1502-A to move in direction 1508 against a force established by spring 1504, allowing the ratchet mechanism to move freely along direction 1506. After each depression of the advance mechanism trigger, piston 1502 would be forced into the next gear 124-A and arrest translational motion 1506

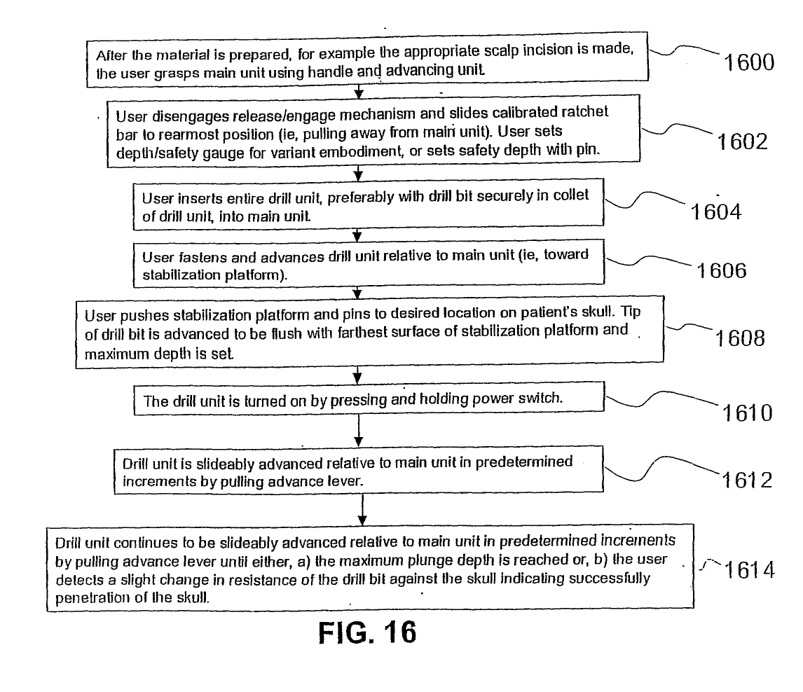

A brief description of the use of the drill will now be provided with reference to FIG. 16 which is a flow chart illustrating the method of use of the drill according to the present invention. For use as a cranial drill it is assumed that an appropriate scalp incision is prepared before performing the following procedure. In step 1600, a user grasps the main unit using the handle and/or the advancing lever. In step 1602, the user disengages the release/engage mechanism and slides the calibrated bar to a rearmost position (i.e., a position opposite the stabilization platform). This step may also include setting a maximum penetration depth by inserting tan optional safety pin into a predetermined position. In step 1604, the user optionally inserts the drill unit including the motor and battery unit preferably with the drill bit in place and fastened by the collet, into the main unit. Step 1604 may include insertion of batteries into the battery cradle. In step 1606, the user fastens and advances the drill unit relative to the main unit. In step 1608, the stabilization platform of the main unit is placed either near to (or against) the material to be drilled (i.e., a patient's skull) and is optionally stabilized by stabilization pins so that the drill bit is located in a desired location relative to the material (i.e., the patient's skull). In step 1610, the drill unit is turned on using the power switch. In step 1612, the drill unit is slideably advanced relative to the main unit in predetermined units (e.g., in 1 mm units) by pulling on the advancing lever. Each complete pull on the advancing lever toward the handle advances the drill unit a predetermined distance (e.g., 1 mm) relative to the longitudinal axis of the main unit so that the drill bit advances relative to the stabilization platform. In step 1614, it is determined whether there is a change in resistance against the drill (i.e., the drill changes rotational speed), indicating that the skull has been perforated and/or the user stops the drill and removes the entire apparatus and determines that the skull has been successfully perforated. Alternatively, when the drill unit has reached its maximum set penetration depth, the entire apparatus can be removed from the drilled material such as the patient's skull.

The materials used for the apparatus according to the present invention can include steel and/or polymeric materials which preferably are medical grade and are suitable for the desired use.

In a preferred embodiment, ABS plastic is used to construct the body of the drill unit and the main unit and a surgical-grade stainless steel is used for the stabilization pins.

The electric motor is preferably a 6-volt electrical motor and can be coupled to gearing to provide the necessary or desired speed and/or torque combination. An optional torque-limiting device can also be included. Moreover, the drill motor/drive and power source are preferably commercial off-the-shelf (COTS) units.

The drill bit preferably has a diameter which is suitable for the desired procedure (e.g., 0.25 inches). The drill bit can be reusable but is preferably disposable.

The collet is preferably a hex-type collet and has a diameter suitable for accepting the drill bit and firmly fastening the drill bit in place so that the drill bit does not slip during use.

The drill unit may include a rechargeable single-use-type drill unit housed in a medical-grade plastic and which can be sterilized.

While the present invention has been described in detail according to an apparatus and a method for performing an cranial burr hole for ventriculostomy and brain biopsy procedures, the present invention can also be used for other procedures which require a burr hole to be formed in a skull or other bony or hard mass of a human being or an animal. While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An apparatus for forming holes, comprising:
a drill unit for drilling holes, the drill unit including a first guide portion;
a calibrated portion connected to the drill unit for positioning the drill unit;
an advancing lever for transferring a force to the calibrated portion;
a body portion including a hinge for locating the advancing lever, the body portion including a handle portion and at least one channel running along a longitudinal portion thereof communicating with the first guide portion and for locating the drill portion; and
a stability platform attached to the body portion adjacent to a rotating portion of the drill unit, the stability portion for stabilizing the body portion relative to an object; wherein pulling on the advancing lever towards the handle portion causes the advancing lever to transfer a force to the calibrated portion, said force causing the drill unit to advance towards the stability platform.

2. The apparatus of claim 1, further comprising stability pins attached to the stability platform.

3. The apparatus of claim 1, further comprising an on/off switch coupled to a motor included in the drill unit.

4. The apparatus of claim 1, wherein the calibrated portion comprises a calibrated bar.

5. The apparatus of claim 1, further comprising a pawl for engaging teeth attached to the calibrated portion.

6. The apparatus of claim 5, wherein the calibrated bar includes an engaging mechanism for engaging the pawl with the teeth, when the engaging mechanism is rotated to a predetermined position.

7. The apparatus of claim 1, further comprising a second pawl for engaging teeth that are attached to the calibrated portion

8. The apparatus of claim 1, further comprising a first and second pawls for transferring forces to the calibrated portion.

9. An apparatus for forming holes, comprising:
a motor for providing a rotational force for rotating a drill bit;
a carrier unit for locating the motor, the carrier unit including at least a first guide portion;
a calibrated portion connected to the carrier portion, the calibrated portion for positioning the carrier unit;
an advancing lever for transferring a force to the calibrated portion;
a body portion including a hinge for locating the advancing lever, the body portion including handle portion and at least one channel running along a longitudinal portion thereof communicating with the first guide portion for locating the drill portion; and
a stability platform attached to an end of the body portion, the stability platform for stabilizing the body portion relative to another object;
wherein pulling on the advancing lever towards the handle portion causes the advancing lever to transfer a force to the calibrated portion, said force causing the carrier unit to advance towards the stability platform.

10. The apparatus of claim 9, further comprising stability pins attached to the stability platform.

11. The apparatus of claim 9, further comprising an on/off switch attached to the body portion, the on/off switch for turning on the motor.

12. The apparatus of claim 9, wherein the calibrated portion further comprises teeth.

13. The apparatus of claim 9, further comprising at least one pawl for engaging teeth attached to the calibrated portion.

14. The apparatus of claim 13, further comprising a release mechanism for separating the at least one pawl from the teeth.

15. The apparatus of claim 9, further comprising a transmission attached to the carrier and coupled to the motor.

16. The apparatus of 9, further comprising a scale for indicating a range of motion attached to a ring positioned about one of the motor or a transmission coupled to the motor.

17. A method for forming holes using a drill unit, comprising:
setting a drill bit attached to the drill unit at position behind a stabilization platform;
placing the stabilization platform upon a desired surface to be drilled;
turning drill unit on and advancing the drill unit a predetermined distance relative to a main unit by depressing the an advancing trigger; and
terminating the procedure when the object to be drilled has been perforated.
